(19) United States
(12) Patent Application Publication
(10) Pub. No.: US 2008/0142655 A1
(43) Pub. Date: Jun. 19, 2008

(54) Distance Piece

(75) Inventor: Ulrik Bruhn, Odder (DK)

Correspondence Address: HARNESS, DICKEY & PIERCE, P.L.C., P.O. BOX 8910, RESTON, VA, 20195, US

(73) Assignee: ITOOLS APS, Odder (DK)

(21) Appl. No.: 10/585,953

(22) PCT Filed: Jan. 13, 2005
(86) PCT No.: PCT/DK2005/000016

§ 371 Date: Aug. 30, 2007

(30) Foreign Application Priority Data
Jan. 31, 2004 (DK) PA 2004 00029
May 28, 2004 (DK) PA 2004 00840
Nov. 4, 2004 (DK) PA 2004 01700

(51) Int. Cl. E06B 1/60; F16B 2/14

(52) U.S. Cl. 248/188.2

(57) ABSTRACT

The present invention relates to a distance piece for obtaining and maintaining a given distance between two objects. In particular, the present invention relates to a distance piece comprising a first wedge-formed element (1) having serrated teeth arranged on a surface thereof, and a second wedge-formed element (3) having serrated teeth arranged on a surface thereof, the serrated teeth of the second wedge-formed element being adapted to engage with the serrated teeth of the first wedge-formed element. The second wedge-formed element further comprises means (8) for receiving and guiding the first wedge-formed so that the distance piece may be operated using only one hand.

The present invention relates to a distance piece maintaining a given distance between two objects, such as between a wall and a wooden floor. The distance piece according to the present invention comprises a set of wedge-formed elements movable in relation to each other. By moving the wedge-formed elements relative to each other, the distance between the two objects may be varied within a certain range.

### BACKGROUND OF THE INVENTION

Traditionally, building components such as windows, doors and wooden floors are arranged relative to a building by use of wedges being wedged into a gap between the building and the component. When the component is aligned in the building, final fixation, if necessary, may be made in traditional way by use of screws or nails.

Distance pieces or filling chocks have traditionally been made of pieces of trimmed wood. In resent years, however, various wedges made of plastic have been developed, c.f. e.g. EP 0 8 443 444. Since components like windows and doors were previously kept in place by a screw or nail acting on the component in a direction towards the wedge, the wedges had to be left in place after the final fixation. The Invention of new location screws, which fixate the component in any direction relative to the building has implied new ways of fitting the components, and typically the wedges are removed from the gap as soon as the location screws are attached.

To enable adjustment of the distance between the building and the component, pairs of two wedges are typically inserted in the gap between the building and the component. The wedges are inserted in mutual contact and arranged reversely in respect to each other, so that a sharp edge of one wedge is pointing in the direction of a blunt edge of the other wedge. In that configuration, the spacing between the building and the component may be adjusted by hammering on the blunt edge of one of the wedges, whereby displacement of one wedge in relation to the other wedge results in formation of a larger gap. During fitting of a component Into a building, it can be difficult to keep the wedges in mutual contact, and it often happens that the wedges get separated and fall out of the gap. It is, furthermore, difficult to exactly adjust the distance between the building and the component.

It is an object of the present invention to provide a distance piece for maintaining a given distance between two objects. The distance piece should be arranged so that the distance to be maintained between the two objects may be set using only one hand.

### SUMMARY OF THE INVENTION

The above-mentioned object is complied with by providing a distance piece for obtaining and maintaining a given distance between two objects, the distance piece comprising:
a first wedge-formed element, and
a second wedge-formed element comprising means for receiving the first wedge-formed element so that the first and second wedge-formed elements form a set of abutting surfaces
   wherein at least one of the wedge-formed elements comprise(s) friction increasing means arranged on at least one of the abutting surfaces.

By friction increasing means is meant any arrangement that increases the coefficient of friction compared to a smooth surface. The friction increasing means ensures that the first and second wedge-formed elements are kept in a fixed relationship as long as the first and second wedge-formed elements are mechanically biased towards each other. The friction increasing means may be arranged on a surface of at least one of the wedge-formed elements. Alternatively or in addition, the friction increasing means may be integrated with a surface of at least one of the wedge-formed elements. By integrated is meant that the friction increasing means form(s) an integral part of a surface of at least one of the wedge-formed elements.

Preferably, the friction increasing means comprise serrated teeth arranged on an abutting surface of the first wedge-formed element and serrated teeth arranged on an abutting surface of the second wedge-formed element. However, other friction increasing means may also be applicable. In principle, any material or surface structure providing an increased coefficient of friction may be used. In terms of materials rubber may provide the required increased friction coefficient. In terms of surface structure a rough surface (in contrast to a smooth surface) may also provide the increased friction. Preferably, the first and second wedge-formed elements are in mutual contact and arranged reversely in respect to each other so that a sharp edge of the first wedge-formed element is pointing in the direction of a blunt edge of the second wedge-formed element. The serrated teeth arranged on the first wedge-formed element may be adapted to engage with the corresponding serrated teeth arranged on the second wedge-formed element.

The receiving means of the second wedge-formed element may comprise at least one keyway arranged in a detached part of the second wedge-formed element. The detached part may be provided at the surface having the serrated teeth arranged therein. In order to engage with the second wedge-formed element, the first wedge-formed element may comprise at least one key adapted to engage with the at least one keyway of the second wedge-formed element. By having this key/keyway connection between the first and second wedge-formed elements the two elements become slideable relative to each other.

Furthermore, the distance piece may comprise a guiding arrangement allowing the two elements to slide or move a certain distance relative to each other. Also, the guiding arrangement may comprise a stopping member for preventing the two elements from becoming separated from each other. The guiding arrangement may be implemented as a through-going opening formed as a slit in one wedge-formed element, whereas the stopping member may be formed by the ends or only one end of this slit. The other wedge-formed element may be equipped with a nail adapted to fit onto the slit and slide along a longitudinal direction of the slit. The nail may have a head portion having a width exceeding the width of the nail itself. Also, the width of the head portion exceeds the width of the slit. Thus, the engagement of the nail into the slit keeps the first and second wedge-formed elements together and prevents that the two elements are separated from one another. In order for the head portion to engage into the slit, the slit may have an end region having a width exceeding the width of the slit. The width of this end region is sufficient to receive the head portion of the nail.

The first wedge-formed element may further comprise a flexible element arranged on a surface thereof, the flexible element being adapted to maintain the first wedge-formed element in a fixed relationship with the object abutting the first wedge-formed element. In addition, or alternatively, the second wedge-formed element may further comprise a flexible element arranged on a surface thereof, the flexible element being adapted to maintain the second wedge-formed element in a fixed relationship with the object abutting the second wedge-formed element. The number of flexible elements may in principle be chosen arbitrarily. Thus, each wedge-formed element may have 1, 2, 3, 4, 5 or even more flexible elements.

The flexible element may form an integral part of one of the wedge-formed elements. By integral is meant, that the flexible element is made in the same material as the wedge-formed element into which it is integrated. Furthermore, by integral is meant that the flexible element forms a monolithic element with the wedge-formed element into which it is integrated.

Alternatively, the flexible element may be a separate flexible element attached to the wedge-formed element. Thus, the flexible element may be fabricated from a different material than the wedge-formed element to which it is attached. For example, the wedge-formed element may be fabricated in a polymer-based material, such as plastic, whereas the flexible element may be fabricated from rubber. The flexible element may be implemented as a resilient protrusion mounted in an indentation arranged on the surface of the wedge-formed element. The volume of the indentation is dimensioned to be able to accommodate the resilient protrusion when the protrusion is in a compressed state.

The distance piece may further comprise a connection element interconnecting the first and second wedge-formed elements. The connection element may have several functionalities. First of all, the connection element prevents that the first and second wedge-formed elements are dislocated from each other. Secondly the connection element may serve as a handhold for the distance piece. Thirdly, the connection element may serve as a release mechanism in the situation where the first and second wedge-formed elements are positioned between two objects, such as between a wall and a wooden floor, or between a wall and a door or a window. After having arranged the final fixation between the two objects the user of the distance piece pulls the connection element causing the two wedge-formed elements to release from their mutual engagement. A consequence of this disengagement is that the distance piece may be easily removed from the opening between the two objects.

The first and second wedge-formed elements and the connection element may be made of the same material, preferably as a one-piece component. This material may be a polymer-based material, such as a plastic material.

The distance piece may further comprise user operable hand grips for assisting the user of the distance piece in engaging the first and second wedge-formed elements. Each of the wedge-formed elements may have a hand grip positioned at or near the blunt edge of the element.

### BRIEF DESCRIPTION OF THE DRAWINGS

The present invention will now be explained in further details with reference to the accompanying figures, wherein

FIG. 1 shows the first and second wedge-formed elements forming the distance piece according to the present invention,

FIG. 2 shows the second wedge-formed element from the sharp edge of the element,

FIG. 3 shows the first and second wedge-formed elements interconnected with a connection member,

FIG. 4 shows the first and second wedge-formed elements interconnected with a connection element,

FIG. 5 shows a three-dimensional view of the first and second wedge-formed elements interconnected with a connection element,

FIG. 6 shows a cross-sectional view of the first and second wedge-formed elements having integrated flexible elements, and

FIG. 7 shows a cross-sectional view of the first and second wedge-formed elements having flexible elements formed as resilient protrusions.

While the Invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

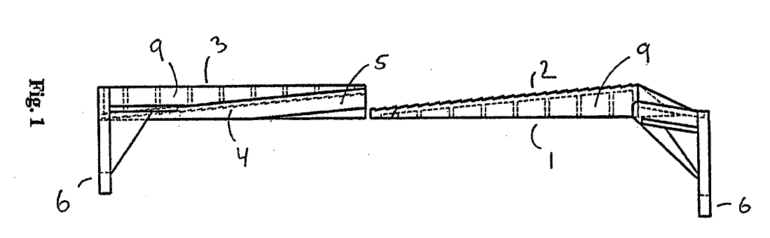

FIG. 1 shows the overall concept of the present invention—namely a first wedge-formed element 1 having serrated teeth arranged on a surface thereof 2, and a second wedge-formed element 3 having serrated teeth arranged on a surface thereof 4. In addition, the second wedge-formed element comprises means 5 for receiving and guiding the first wedge-formed element in a slidable manner. Each of the wedge-formed elements is equipped with user operable hand grips 6 for assisting the user in sliding the two wedge-formed elements 1, 3 into engagement by pushing the wedge-formed elements towards each other. The first and second wedge-formed elements 1, 3 are made in a polymer-based material, such as plastic. Each element is fabricated as a one-piece element. To minimise weight each wedge-formed element is fabricated with a number of compartments 9.

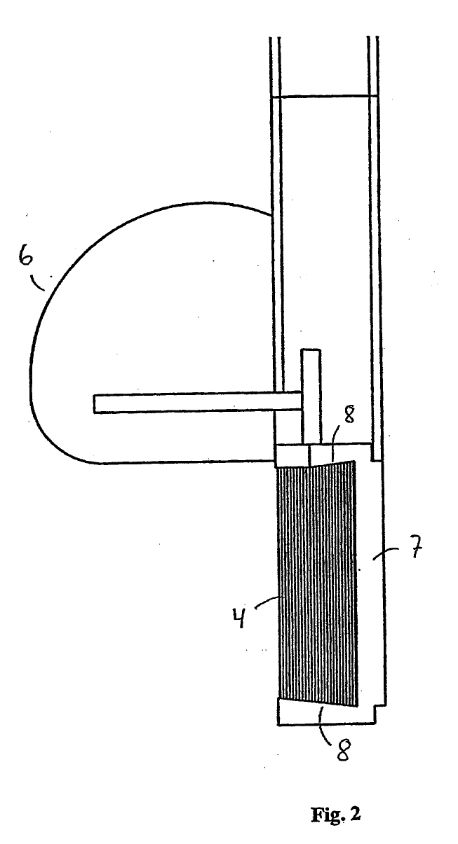

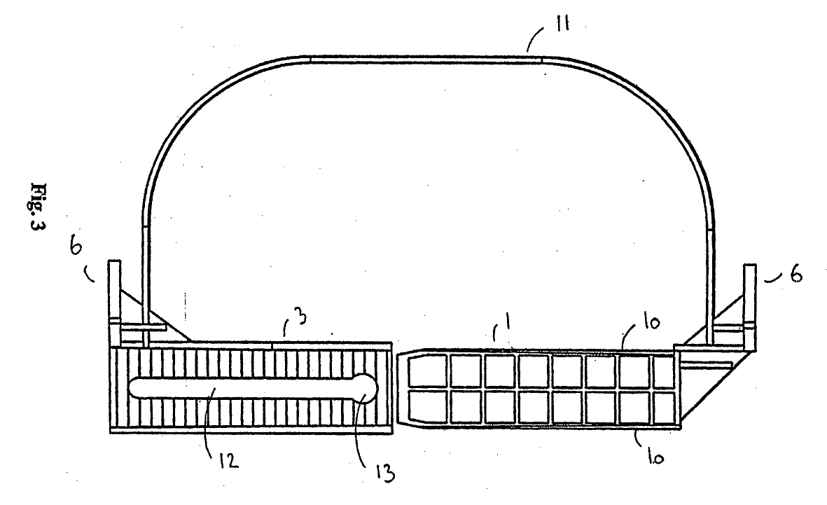

FIG. 2 shows the second wedge-formed element from its sharp edge 7. The means for receiving and guiding the first wedge-formed element is in FIG. 2 shown as two angled surfaces 8. In order for the first wedge-formed element (not shown in FIG. 2) to fit between the angled surfaces 8, the edges 10 (see FIG. 3) between the sharp and blunt edges of the first wedge-formed element 1 are angled in a similar manner. The user operable hand grips 6 are dimensioned so that they correspond to the size of a typical finger end of an adult person.

FIG. 3 shows an embodiment of the present invention where the first and second wedge-formed elements (1, 3) are interconnected by a flexible connection member 11. As already mentioned, the flexible connection element 11 has several functionalities, namely it prevents that the first and second wedge-formed elements (1, 3) are dislocated from each other, it serves as a handhold for the distance piece, and it serves as a release mechanism in the situation where the first and second wedge-formed elements are positioned between two objects, such as between a wall and a wooden floor, or between a wall and a door or a window. In the latter situation, and after final fixation has been arranged between the two objects, the user of the distance piece pulls the connection element away from the opening between the two objects whereby the two wedge-formed elements are released from their mutual engagement. The wedge-formed elements 1, 3 and the connection element 11 are in FIG. 3 shown as a one-piece component. This one-piece component could for example be made in a polymer-based material, such as plastic.

In the embodiment shown in FIG. 3 the second wedge-formed element 3 has a slit in the longitudinal direction of the element. At the end of the slit (near the sharp edge of the element) a region 13 having an extended width is provided. This extended region 13 is adapted to receive a nail (not shown) attached to, or integrated with, the first wedge-formed element 1. The nail of the first wedge-formed element 1 is adapted to engage with the slit portion 12 when the first wedge-formed element 1 engages the receiving and guiding means 8 of the second wedge-formed element 3, and when the two wedge-formed elements are performing a sliding movement relative to each other so as to bring them into and out of engagement. The nail has a head portion having a width exceeding the width of the nail itself. The wider head portion is adapted to fit into the extended region 13. It is obvious that the slit (12, 13) may as well be arranged in the first wedge-formed element. Similarly, the nail may be attached to, or integrated with, the second wedge-formed element.

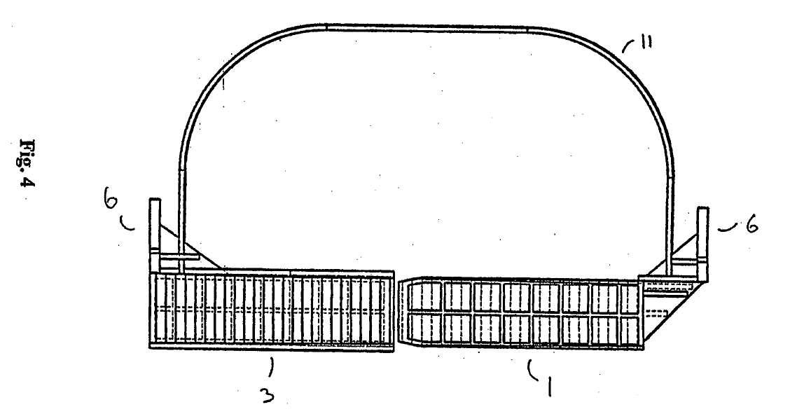

FIG. 4 shows an embodiment very similar to the embodiment shown in FIG. 3—however the slit in the second wedge-formed element has been omitted.

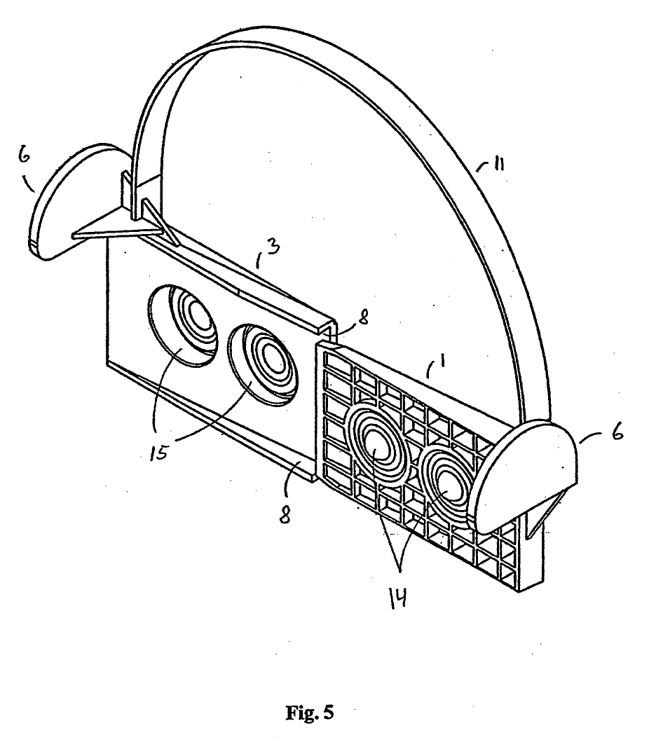

FIG. 5 shows a three-dimensional view of the distance device comprising flexible elements 14 arranged on surfaces of the first and second wedge-formed elements (1, 3). These flexible elements are adapted to maintain the wedge-formed elements in a fixed relationship with the object abutting the wedge-formed elements. A hollow region 15 is provided behind each of the flexible elements 14 for allowing the flexible elements 14 to move in and out of the surface region holding the flexible elements 14.

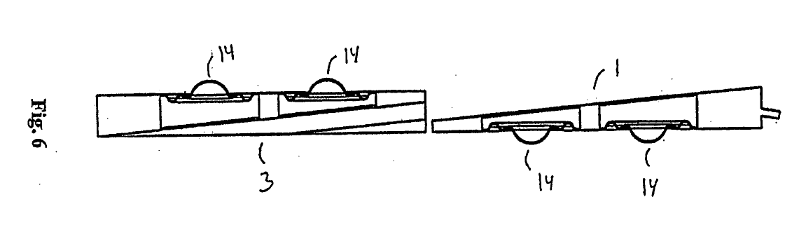

In FIG. 5 and FIG. 6 the flexible elements form an integral part of the wedge-formed elements. By integral is meant, that the flexible elements are made in the same material as the wedge-formed element into which it is integrated, and that a given flexible element forms a monolithic element with the wedge-formed element into which it is integrated.

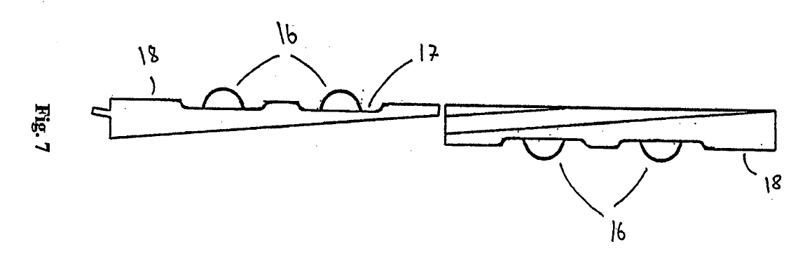

Alternatively, the flexible element can be a separate flexible element attached to the wedge-formed element—see FIG. 7. Thus, the flexible element may be fabricated from a different material than the wedge-formed element to which it is attached. For example, the wedge-formed element may be fabricated in a polymer-based material, such as plastic, whereas the flexible element may be fabricated from rubber.

In FIG. 7 the flexible element is constituted by a resilient protrusion 16 made of rubber. The resilient protrusion 16 is located in an indentation 17 formed into the surface of the wedge-formed elements. In a relaxed state of the resilient protrusion, the resilient protrusion does not occupy the full indentation. However, when a wedge-formed element is pressed against an object its resilient protrusion or protrusions is/are pressed into the indentation. Thus, the indentations should be capable of absorbing the resilient protrusions in a compressed state of the protrusion—for example when the wedge-formed element (surface 18) is pressed against another object.

1. A distance piece for obtaining and maintaining a given distance between two objects, the distance piece comprising:
a first wedge-formed element, and
a second wedge-formed element comprising means for receiving the first wedge-formed element so that the first and second wedge-formed elements form a set of abutting surfaces
wherein at least one of the wedge-formed elements comprise(s) friction increasing means arranged on at least one of the abutting surfaces.

2. A distance piece according to claim 1, wherein the friction increasing means comprises serrated teeth arranged on an abutting surface of the first wedge-formed element and/or serrated teeth arranged on an abutting surface of the second wedge-formed element.

3. A distance piece according to claim 2, wherein the serrated teeth arranged on the first wedge-formed element are adapted to engage with the corresponding serrated teeth arranged on the second wedge-formed element.

4. A distance piece according to claim 1, wherein the receiving means of the second wedge-formed element comprises at least one keyway.

5. A distance piece according to claim 4, wherein the first wedge-formed element comprises at least one key adapted to engage with the at least one keyway of the second wedge-formed element.

6. A distance piece according to claim 1, wherein the first wedge-formed element further comprises a flexible element arranged on a surface thereof, the flexible element being adapted to maintain the first wedge-formed element in a fixed relationship with the object abutting the first wedge-formed element.

7. A distance piece according to claim 1, wherein the second wedge-formed element further comprises a flexible element arranged on a surface thereof, the flexible element being adapted to maintain the second wedge-formed element in a fixed relationship with the object abutting the second wedge-formed element.

8. A distance piece according to claim 6, wherein the flexible element forms an integral part of the wedge-formed element.

9. A distance piece according to claim 6, wherein the flexible element is a separate flexible element attached to the wedge-formed element.

10. A distance piece according to claim 1, further comprising a connection element interconnecting the first and second wedge-formed elements.

11. A distance piece according to claim 10, wherein the first and second wedge-formed elements and the connection element are made of the same material.

12. A distance piece according to claim 10, wherein the first and second wedge-formed elements and the connection element are made as a one-piece component.

13. A distance piece according to claim 10, wherein the first and second wedge-formed elements and the connection element are made of a polymer-based material, such as a plastic material.

14. A distance piece according to claim 1, further comprising user operable hand grips for assisting the user of the distance piece in engaging the first and second wedge-formed elements.

15. A distance piece according to claim 1, wherein the second wedge-formed element comprises a slit adapted to receive a nail of the first wedge-formed element, the slit being arranged as a through-going opening in the surface comprising the friction increasing means.
